(19) United States
(12) Patent Application Publication
(10) Pub. No.: US 2011/0070573 A1
(43) Pub. Date: Mar. 24, 2011

(54) INSTRUCTIONAL CONTENT AND STANDARDS ALIGNMENT PROCESSING SYSTEM

(75) Inventors: Bret Carlton DENNIS, Ashburn, VA (US); JoAnna Hunt, Arlington, VA (US); Claude Vervoort, Pointe Claire (CA); Joel Lindsey, Kensington, MD (US); Deborah Everhart, Washington, DC (US)

(73) Assignee: BLACKBOARD INC., Washington, DC (US)

(21) Appl. No.: 12/565,692

(22) Filed: Sep. 23, 2009

(51) Int. Cl. G09B 19/00

(52) U.S. Cl. 434/433

(57) ABSTRACT

An instructional content and standards alignment processing system is disclosed. The system includes a computer-readable memory configured to store information indicative of instructional content, a first educational standard, and a second educational standard, and configured to store at least one alignment between the instructional content and the first educational standard and at least one mapping between the first educational standard and the second educational standard. The system also includes a processor configured to automatically generate at least one alignment between the instructional content and the second educational standard based on the mapping between the first educational standard and the second educational standard. The computer-readable memory is configured to store the alignment between the instructional content and the second educational standard after the alignment is confirmed by a user. Methods and machine-readable mediums are also disclosed.

### BACKGROUND

1. Field

The present disclosure generally relates to computer software and hardware systems, and more particularly, to a system for the processing of instructional content and standards.

2. Description of the Related Art

As part of providing quality educational opportunities, many academic institutions are interested in assessing and evaluating their performance, the performance of units and individuals within their institutions, and addressing required educational standards with instructional content and resources. These institutions can include, for example, online (e.g., virtual) institutions, K-12 schools, colleges, universities, multi-campus university systems, and institutions for professional education. One purpose of assessment involves collecting and documenting the evidence needed for satisfying the objectives of regional or national accreditation bodies. Another purpose is to allow the institution to make informed and objective decisions about, for example, instructional content, course offerings, and educational effectiveness. Yet another purpose is to track student progress towards institutional and curricular goals, both individually and collectively.

Academic institutions engage in a complex process of associating curriculum resources, lesson plans, and other assessment items with specific state educational standards and other types of goals and objectives to ensure that instructional content (e.g., course, unit, and lesson plans) are in alignment with those standards. Although educational standards, which are a common example of general educational objectives, are unique from state to state, there is often considerable overlap between state educational standards. Additionally, educational standards are hierarchical in nature; each state educational standard often has two or more levels of description. In practice, most alignment happens at the lowest level, and may vary by state, school district, and individual schools, but the relationship created by the alignment between instructional content and a low level state educational standard rolls up to inform general alignment at higher level state educational standards.

Instructors, administrators, and other staff often spend significant time attempting to manually align or otherwise associate their instructional content and assessments with state educational standards. This alignment is error prone, and collaboration between instructors, administrators, staff, and institutions is constrained due to both the voluminous paper-based resources and materials generated and required for manually aligning instructional content and assessments with state educational standards, and the limited use of web-based and electronic tools.

The alignment process is made even more difficult because state educational standards change periodically and re-alignment of the instructional content and assessments with the changed state educational standards is often necessary.

### SUMMARY

Embodiments of the instructional content and standards alignment processing system disclosed herein provide for user-generation of an alignment, and user-confirmation of an automatic alignment or re-alignment, of instructional content with a second educational standard based on the pre-existing relationships of the instructional content with a first educational standard, and the first educational standard with the second educational standard. The system is further configured to provide for user-generation of a mapping, and user-confirmation of an automatic mapping or re-mapping, of a first educational standard with a third educational standard based on a pre-existing mapping between the first educational standard and a second educational standard, and the second educational standard with the third educational standard. The system is also configured to generate new alignments to replace existing alignments, and generate new mappings to replace existing mappings.

In certain embodiments of the disclosure, an instructional content and standards alignment processing system is provided. The system includes a computer-readable memory configured to store information indicative of instructional content, a first educational standard, and a second educational standard, and configured to store at least one alignment between the instructional content and the first educational standard and at least one mapping between the first educational standard and the second educational standard. The system also includes a processor configured to automatically generate at least one alignment between the instructional content and the second educational standard based on the mapping between the first educational standard and the second educational standard. The computer-readable memory is configured to store the alignment between the instructional content and the second educational standard after the alignment is confirmed by a user.

In certain embodiments of the disclosure, a method for associating instructional content is provided. The method includes receiving at least one alignment between instructional content and a first educational standard, and at least one mapping between the first educational standard and a second educational standard. The method also includes generating at least one alignment between the instructional content and the second educational standard based on the mapping between the first educational standard and the second educational standard. The method further includes receiving, from a user, a confirmation of the alignment between the instructional content and the second educational standard, and storing the confirmed at least one alignment between the instructional content and the second educational standard.

In certain embodiments of the disclosure, a computer-readable medium having computer-executable instructions for causing a processor to execute instructions to associate instructional content by performing certain steps is provided. The steps include receiving at least one alignment between instructional content and a first educational standard, and at least one mapping between the first educational standard and a second educational standard. The steps also include generating at least one alignment between the instructional content and the second educational standard based on the mapping between the first educational standard and the second educational standard. The steps further include receiving, from a user, a confirmation of the alignment between the instructional content and the second educational standard, and storing the confirmed at least one alignment between the instructional content and the second educational standard.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a diagram illustrating an instructional content and standards alignment processing system according to certain embodiments.

FIG. 2 is a flow chart illustrating an exemplary mapping process using the instructional content and standards alignment processing system of FIG. 1.

FIG. 3 is a flow chart illustrating an exemplary process of obtaining a mapping for the process of FIG. 2.

FIG. 4 is a flow chart illustrating an exemplary process of creating a mapping for the process of FIG. 2.

FIG. 5 is a flow chart illustrating an exemplary process for providing different options for existing mappings from the process of FIG. 2.

FIG. 6 is a flow chart illustrating an exemplary process for confirming and acting on a mapping from the process of FIG. 2.

FIG. 7 is a flow chart illustrating an exemplary process of updating instructional content alignments based on the confirmed mapping from the process of FIG. 2.

FIG. 8A is a sample screenshot, displayed by the display device associated with the instructional content and standards alignment processing system of FIG. 1, of base instructional content aligned to a base standard during the operation of FIG. 7.

FIG. 8B is a sample screenshot, of a list of base standards (i.e., the base standard of FIG. 8A) mapped to target standards.

FIG. 8C is a sample screenshot of a user interface for modifying the mapping of FIG. 8B.

FIG. 8D is a sample screenshot of a user interface for adding additional target standards to the mapping of FIG. 8B.

FIG. 8E is a sample screenshot of a resulting alignment between the base instructional content of FIG. 8A and the target standards of FIG. 8B according to the exemplary process of FIG. 7.

FIG. 9 is a block diagram illustrating an example of a computer system with which the instructional content and standards alignment processing system of FIG. 1 can be implemented.

### DETAILED DESCRIPTION

There is a problem, in educational standards alignment, of generating incorrect, time consuming, and constrained alignments of re-aligned instructional content to new, changed, or related educational standards due to the manual procedure of aligning instructional content to older or obsolete educational standards. This and other problems are addressed and solved, at least in part, by embodiments of the present disclosure, which include an instructional content and standards alignment processing system. The system includes a computer-readable memory configured to store information indicative of instructional content, a first educational standard, and a second educational standard, and configured to store at least one alignment between the instructional content and the first educational standard and at least one mapping between the first educational standard and the second educational standard. The system also includes a processor configured to automatically generate at least one alignment between the instructional content and the second educational standard based on the mapping between the first educational standard and the second educational standard. The computer-readable memory is configured to store the alignment between the instructional content and the second educational standard after the alignment is confirmed by a user.

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail not to obscure the disclosure.

As discussed herein, “instructional content” includes educational resources, lesson plans, assessment items, artifacts, papers, tests, surveys, quizzes, collaborative exercises, and assignments. In general, as discussed with regards to an assessment, a “standard” (or “educational standard”) includes a statement of what a student (or “learner”) should know or be able to do. A standard is measurable, and is often more specific than a goal. A standard may not be related to a specific activity, instruction, performance, etc. or timeframe. Standards are frequently generated by organizations external to an academic institution (e.g. state governments and accrediting agencies) as a means to standardize measurement of performance or learning across multiple organizations. A state or government institution that publishes a standard or set of standards in hardcopy format may change to an electronic publishing format in the future. An educational standard is a common example of the how educational goals and objectives are used more generally.

As discussed herein, the association of instructional content to an educational standard is an alignment, and the association of an educational standard to another educational standard is a mapping (or “connection”). Both mappings and alignments are considered associations.

As discussed herein, a user is a person who uses the instructional content and standards alignment processing system. A user may have a user account (associated with at least one user role) that identifies the user by a username. To log in to the user account, a user is typically required to authenticate himself with a password or other credentials for the purposes of accounting, security, logging, and resource management.

While many examples are provided herein that include educational standards, the principles of the present disclosure contemplate other types of goals and objectives from many different sources. Furthermore, while many examples are provided herein that include an educational institution, the principles of the present disclosure contemplate other types of organizations as well. For example, corporations and governmental entities are all considered within the scope of the present disclosure. An institution may also be a consortium of schools and/or campuses. In general terms, an institution is an operating unit and is, itself, made up of different operating units that may correspond to campuses, colleges, departments, sub-departments, etc. The systems and methods described herein do not require any particular arrangement of operating units but, instead, allow the institution to model its organization into a hierarchy of operating units for purposes of management, planning, and reporting of assessment efforts.

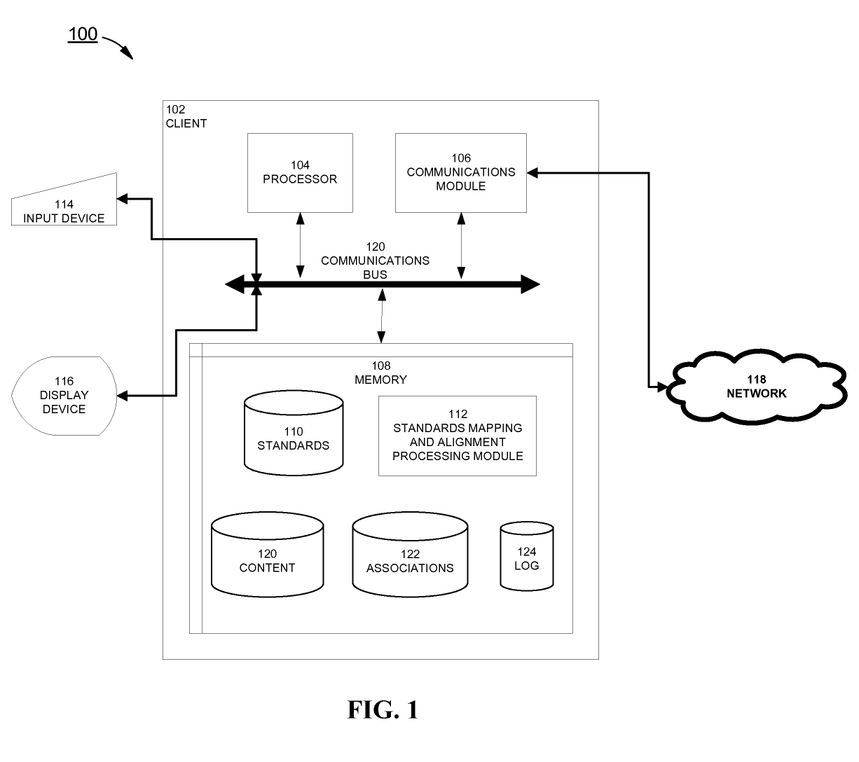

FIG. 1 is a diagram illustrating an instructional content and standards alignment processing system 100 according to certain embodiments. The system 100 includes a client 102, input device 114, and a display device 116. The client 102 can represent a computer, a laptop computer, a thin client, a personal digital assistant (PDA), a portable computing device, a mobile intelligent device (MID), a system as a service (SAAS), or a suitable device with a processor and memory. The client 102 can be stationary or mobile. The client 102 may also be managed by a host, such as over network 118.

The display device 116 is a type of output module. Other types of output modules can be used, including, without limitation, a processor, a printer, audible indicators such as speakers, or other visual indicators such as display screens, including a cathode ray tube (CRT) display, vacuum fluorescent display (VFD), light emitting diode (LED) display, plasma display panel (PDP), liquid crystal display (LCD), organic light emitting diode (OLED), or surface-conduction electron-emitter display (SED). The display device 116 is configured to display or otherwise output information provided by the processor, such as alignments between instructional content and educational standards, and mappings between educational standards.

The input device 114 is configured to provide input, to the client 102, the input having been processed by the processor 104. A wired or wireless input device 114 can be used, such as, but not limited to, a keyboard, a touch-screen display, a mouse, a microphone, a magnetic card reader, a biometric reader-sensor, a proximity reader, a radio frequency (RF) identification reader, and a symbology reader. The input device 114 can also include assistive technology devices (i.e., accessibility devices) such as, but not limited to, modified keyboards, foot mice, LOMAK keyboards, trackballs, joysticks, graphics tablets, touchpads, a microphone with speech recognition software, sip-and-puff input, switch access, vision-based input devices, keyboard shortcuts, and hardware configured to work with software customized for assistive access.

In certain embodiments, the client 102 is connected to a network 118 via a communications module 106. The communications module 106 is connected to the network 118, for example, via a modem connection, a local-area network (LAN) connection including the Ethernet, or a broadband wide-area network (WAN) connection, such as a digital subscriber line (DSL), cable, T1, T3, fiber optic, or satellite connection. The network 118 can be a LAN network, a corporate WAN network, or the Internet, and may include features such as a firewall. The processor 104, communications module 106, memory 108, input device 114, and display device 116 communicate using a communications bus 120.

The memory 108 of the client 102 includes a standards data store 110, content data store 120, associations data store 122, and a standards mapping and alignment processing module 112. The standards data store 110 includes information indicative of educational standards, and the content data store 120 includes data indicative of instructional content. The associations data store 122 stores: (1) associations between the educational standards of the standards data store 110 and the instructional content of the content data store 120, (2) associations between educational standards within the standards data store 110, and (3) associations between instructional content within the content data store 120. The associations data store 122 and content data store 120 may be accessible by other systems over the network 118, such that the mappings and alignments in the associations data store 122 and instructional content from the content data store 120 can be shared and reused.

Several examples will now be presented that use the system 100 disclosed herein. As a first example, a mapping can be modified in the system 100 and exported (as described in further detail below), and then reused by another system. As another example, instructional content from another system can be obtained over network 118 and stored in content data store 120 for use by the system 100. By way of another example, if the system 100 were located at a certain school, a mapping can be created and/or managed external to the system 100, such as at a district office, and added to the standards data store 110 of the system 100 at the school over the network 118. As yet another example, instructional content in the content data store 120 can be associated with alignments (e.g., added, copied, or deleted) based on previously existing associations between the instructional content or metadata of the instructional content. As another example, mappings and or alignments within the system can be selectively updated, such as the application of a map from an external source to a subset of the system or content based on information from the external source, e.g. within a district, a school is limited to applying changes to courses within that school, not all courses within the district. As a further example, instructional content, standards, and alignments obtained from an interface with an external system, such as an outcomes management system, can be imported into the content data store 120, standards data store 110, and associations data store 122. Exemplary outcomes management systems are disclosed in U.S. patent application Ser. No. 12/151,593 entitled “Systems and Methods for Goal Attainment in Achievement of Learning,” U.S. patent application Ser. No. 12/151,580 entitled “Systems and Methods for Goal Attainment in Post-Graduation Activities,” and U.S. patent application Ser. No. 12/151,592 entitled “Systems and Methods for Goal Attainment in Alumni Giving,” which are incorporated herein by reference in their entireties.

The standards mapping and alignment processing module 112 stores computer-readable instructions executable by processor 104 to generate new associations (e.g., mappings or alignments) to store in the associations data store 122 based on pre-existing associations already stored in the associations data store 122 and/or user-generated associations between the educational standards and/or the instructional content received via the input device 114. For example, if the associations data store 122 includes (1) information indicative of an alignment between base instructional content, a course syllabus (stored in the content data store 120), and a base standard from a previous year (stored in the standards data store 110), and (2) information indicative of a mapping between the base standard and a target standard from a current year (also stored in the standards data store 110), the processor 104, executing instructions stored in the standards mapping and alignment processing module 112, will advantageously generate a new alignment between the course syllabus (i.e., the base instructional content) and the target standard from the current year. Thus, the need for a user to manually align the course syllabus to the standard from the current year is avoided. The new alignment can be modified based on input from the user. If the alignment and/or modifications are displayed to the user via the display device 116, the user may then confirm the new alignment and/or his modifications to the alignment using the input device 114.

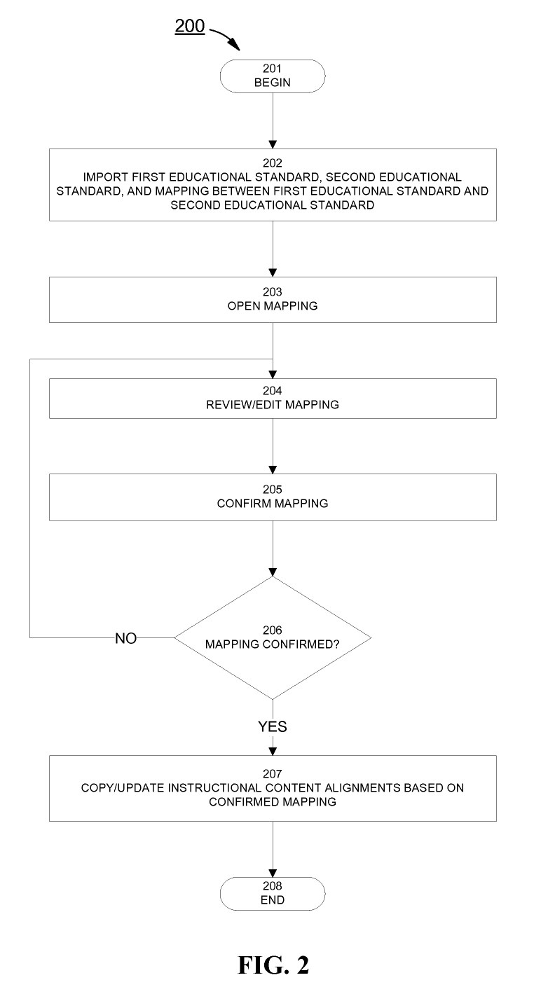

The standards mapping and alignment processing module 112 also stores computer-readable instructions to allow a user to provide and store, in the associations data store 122, additional input regarding the stored associations. For example, using input device 114, the user can provide notes on the purpose of an alignment between a specific standard and instructional content. As another example, using input device 114, the user can provide notes on why the user modified an alignment between a specific standard and instructional content. The standards mapping and alignment processing module 112 also stores computer-readable instructions to allow a user to make use of portions of the standards management process, such as generating user defined (or “custom”) standards, into the standards mapping processes 200 of FIG. 2. For example, using the input device 114, the user can instruct the system 100 to copy a user defined standard shown in the set of base standards and stored in the standards data store 110 to its proper location in the set of target standards also stored in the standards data store 110 such that the user-generated standards can be processed with the other standards stored in the standards data store 110.

The standards mapping and alignment processing module 112 further stores computer-readable instructions to generate a log 124 of system 100 usage to be stored in the memory 108. The log 124 includes information indicative of the user account associated with new associations or changes to associations made in the memory 108, access attempts, and date and time information for system 100 usage. The log 124 may be implemented using metadata stored in the memory 108.

The standards mapping and alignment processing module 112 stores computer-readable instructions to have the display device 116 display the status of associations of instructional content and standards. Associations can have an (1) active status, where a user account accessing the system 100 has authorization to access and/or change the association, (2) inactive status, or (3) in review status, the latter two visible and usable by those users who have authorization to manage standards in general and/or in certain courses or contexts on the system 100.

The instructional content and standards alignment processing system 100 can be used in a variety of situations. As a first example, within state educational standards, if base instructional content, such as an Algebra course lesson plan, is aligned to an old state math educational standard, and a new target state math educational standard is released, then, based on a mapping of the old state math educational standard to the new target state math educational standard, the Algebra course lesson plan can automatically be re-aligned to the new target state math educational standard. As a second example, for state to national standards, if the base instructional content Algebra course lesson plan is aligned to a state math educational standard, and a new target national math educational standard is released, then, based on a mapping of the state math educational standard to the new target national math educational standard, the Algebra course lesson plan can automatically be re-aligned to the new target national math educational standard.

As a third example, across disciplines, if the base instructional content Algebra course lesson plan is aligned to a state math educational standard, and a state technology educational standard is made available, then, based on a mapping of the state math educational standard to the target technology educational standard, the Algebra course lesson plan can automatically be re-aligned to the target technology educational standard. As a fourth example, across multiple states, if base instructional content, an English course syllabus from a virtual institution such as online university, is aligned to a first state reading standard, and the virtual institution seeks to offer courses to students in a second state, then, based on a mapping of the first state's reading standard to the target second state's reading standard, the English course syllabus can automatically be re-aligned to the target second state's reading standard. In either example, if several re-mappings need to occur, then the re-mappings may be processed together in one batch operation.

FIG. 2 is a flow chart illustrating an exemplary mapping process 200 using the instructional content and standards alignment processing system 100 of FIG. 1. The mapping process 200 proceeds from beginning step 201 to step 202 in which a first educational standard, a second educational standard, and a mapping between the first educational standard and second educational standard are imported. The first educational standard and second educational standard are, for example, imported into the standards data store 110, and the mapping is imported into the the associations data store 122. In certain embodiments, the mapping is included with the first educational standard and the second educational standard. Next, in step 203, the mapping is opened (e.g., for analysis and/or viewing), and in step 204, the mapping is reviewed and optionally edited. The mapping may be obtained from the associations data store 122. The mapping is presented for confirmation in step 205, and, if the mapping is confirmed in decision step 206, the process 200 proceeds to step 207 in which instructional content aligned with the first educational standard has alignments that are copied and updated to be aligned with the second educational standard based on the confirmed mapping from decision step 206. If, however, in decision step 206 the mapping was not confirmed, the process 200 returns to step 204. The process 200 ends in step 208.

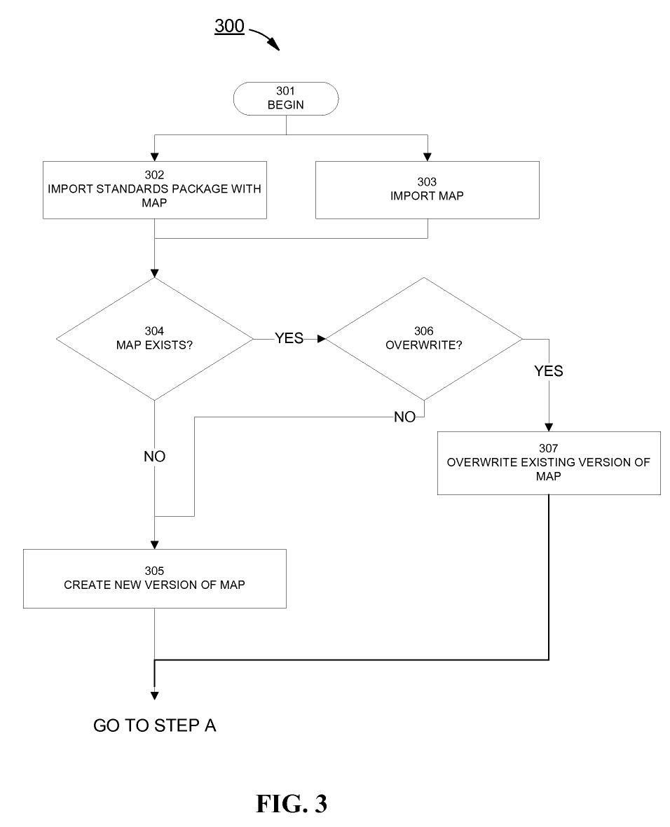

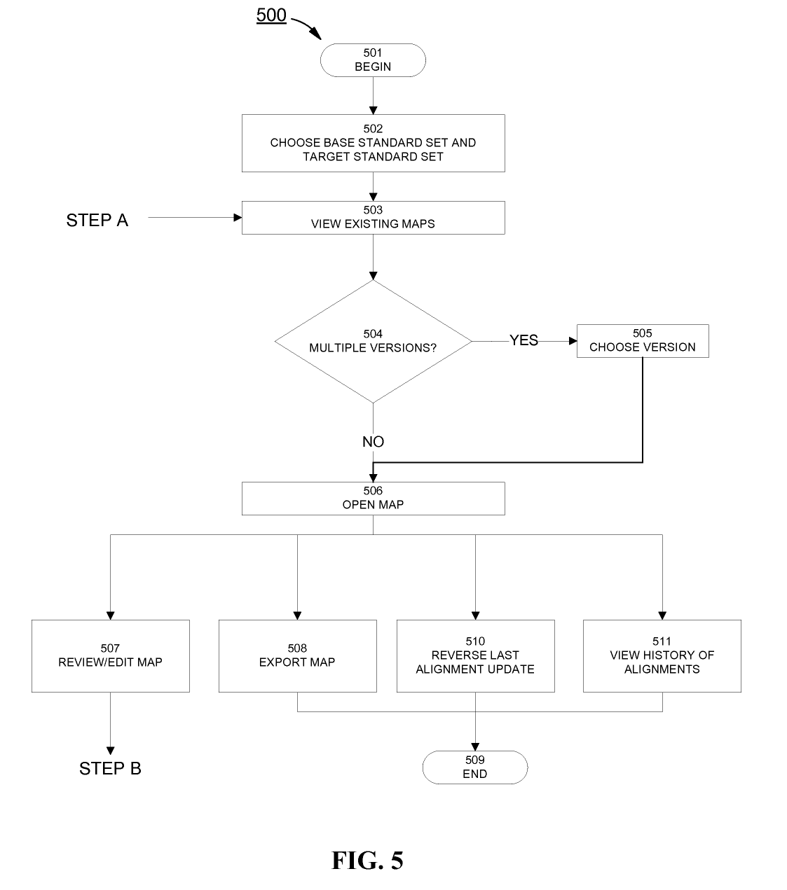

FIG. 3 is a flow chart illustrating an exemplary process 300 of obtaining the mapping of process of FIG. 2. The process 300 proceeds from beginning step 301 to step 202 if a standards package with a map (e.g., at least one standard that includes a mapping to another standard) is imported, or to step 203 if a map is imported. In decision step 304, if an appropriate map exists, then in decision step 306 the map can be overwritten. If a map does not exist in decision step 304, the process 300 proceeds to step 305. Returning to decision step 304, if the map is selected to be overwritten, the process 300 proceeds to step 307 in which the existing version of the map is overwritten. If, however, in decision step 304 the map is not selected to be overwritten, the process 300 proceeds to step 305. In step 305, a new version of the map is created. The process 300 then proceeds to step A, which is described in FIG. 5 below.

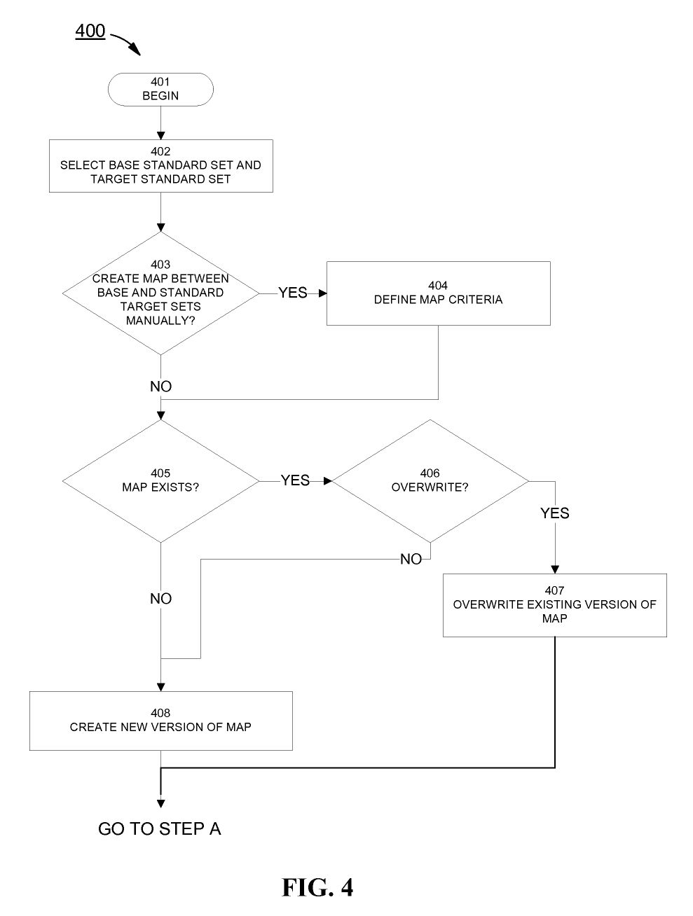

FIG. 4 is a flow chart illustrating an exemplary process 400 of creating a mapping for the process of FIG. 2. The process 400 proceeds from beginning step 401 to step 402 in which a base set of standards and a target set of standards are selected. In decision step 403, a map between the base set of standards and the target set of standards can be created manually. If the map is created manually, then the process 400 proceeds to step 404 in which the map criteria are defined, and from step 404 the process 400 proceeds to decision step 405. Examples of how map criteria can be defined include semantic matching of text in standards, usage based on existing alignments, and metadata on alignments or standards (status, owner, purpose, categories, notes, and date). If a map is not created manually in decision step 403, then the process 400 proceeds to decision step 405. In decision step 405, if a map does not exist, then the process 400 proceeds to step 408 in which a new version of a mapping between the base set of standards and the target set of standards is created. If a map does not exist in decision step 405, then the process 400 proceeds to decision step 406, where a decision is made whether to overwrite the map. If a decision is made not to overwrite the map, the process 400 proceeds to step 408 described above. If a decision is made to overwrite the map in decision step 406, then in step 407 the map is overwritten. The process 400 then proceeds to step A, which is described in FIG. 5 below.

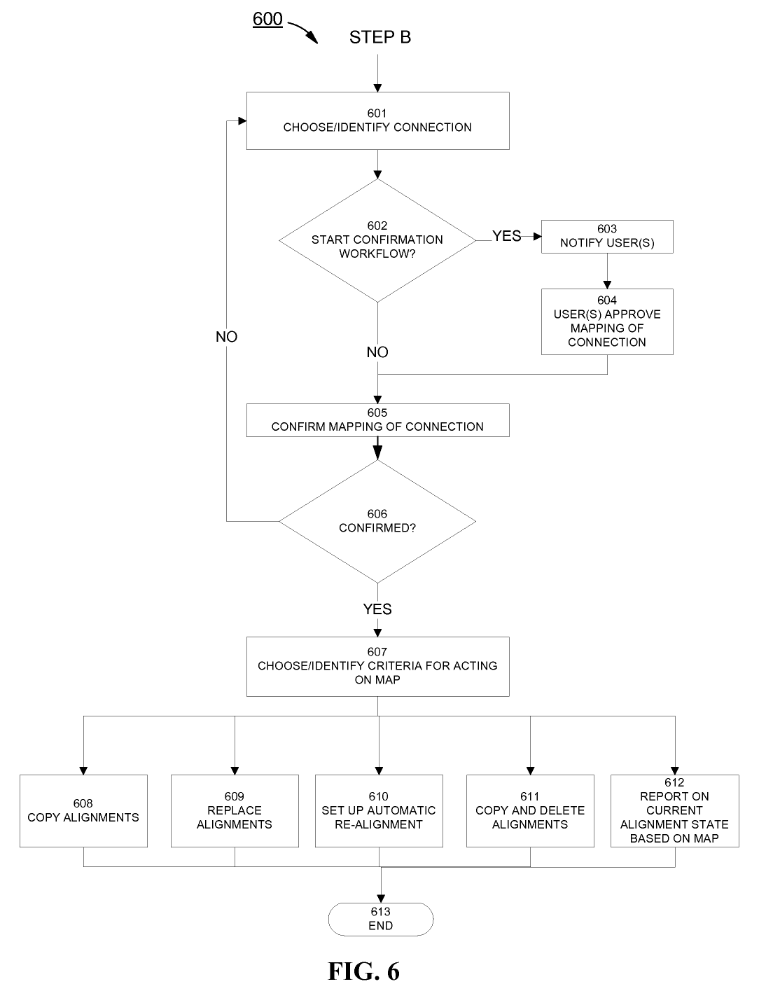

FIG. 5 is a flow chart illustrating an exemplary process 500 for providing different options for existing mappings from the process 200 of FIG. 2. The process 500 proceeds from beginning step 501 to step 502 in which a base standard set and a target standard set are chosen. Next, in step 503, which may either be reached from step 502, or from steps 305 (of FIG. 3), 407, or 408 (of FIG. 4) discussed above, existing mappings between the base standard set and the target standard set are viewed. If multiple versions exist, as decided in decision step 504, then a version is selected in step 505 and the process 500 proceeds to step 506, otherwise the process 500 immediately proceeds from decision step 504 to step 506. In step 506, the map is opened, and from step 506, four options are available. In one option, step 507, the map may be reviewed or edited, from which the process 500 proceeds to step B discussed in FIG. 6 below. In another option, step 508, the map is exported, and the process 500 ends in step 509. For example, the map may be exported into an archive in a common format such that it can be exchanged and used by other institutions. In a further option, step 510, the last alignment update of map is reversed, and the process 500 ends in step 509. In yet another option, step 511, a history of the alignments associated with the map is viewed, and the process 500 ends in step 509.

FIG. 6 is a flow chart illustrating an exemplary process 600 for confirming and acting on a mapping from the process of FIG. 2. The process 600 proceeds from step 507 of FIG. 5 to step 601, in which the mapping (or connection) between the base standard set and the target standard set is chosen or identified. The mapping may be identified by, for example, all standards in the set of standards, grade level, concept or topic, or metadata on standards (e.g., tags, categories, or notes). Next, in decision step 602, a confirmation workflow (of the chosen/identified mapping) may be started. If the confirmation workflow is started in decision step 602, the process 600 proceeds to step 603 in which users, who are selected to confirm the mapping, are notified, and those users then approve of the mapping in step 604. The process 600 then proceeds to step 605. If, however, the confirmation workflow is not started in decision step 602, the process 600 then proceeds directly to step 605.

In step 605, the mapping is presented for confirmation. If the mapping is confirmed in decision step 606, the process 600 proceeds to step 607, otherwise the process 600 returns to step 601. In step 607, criteria for acting on the mapping between the base standard set and the target standard is chosen or identified. The criteria can include, for example, all standards in the map, all standards in the connection, all alignments, all alignments in specific courses, all alignments in specific categories, all alignments in a section of an institution (e.g., department or school), alignments for specific content types, alignments on content stored in designated areas, alignments based on metadata (e.g., tags, categories, notes, or dates), and the metadata and location of the instructional content.

From step 607, the process 600 may proceed along multiple routes. In step 608, the alignments between the base standard set and the target standard are copied. In step 609, the alignments between the base standard set and the target standard are replaced. In step 610, the alignments between the base standard set and the target standard are set up for automatic re-alignment. In step 611, the alignments between the base standard set and the target standard are copied and/or deleted. In step 612, a report is provided on the current state of alignments based on the mapping between the base standard set and the target standard. The report can include a display of the proposed changes to the alignments before they are made. The process 600 proceeds from either steps 608-612 to step 613, in which the process 600 ends.

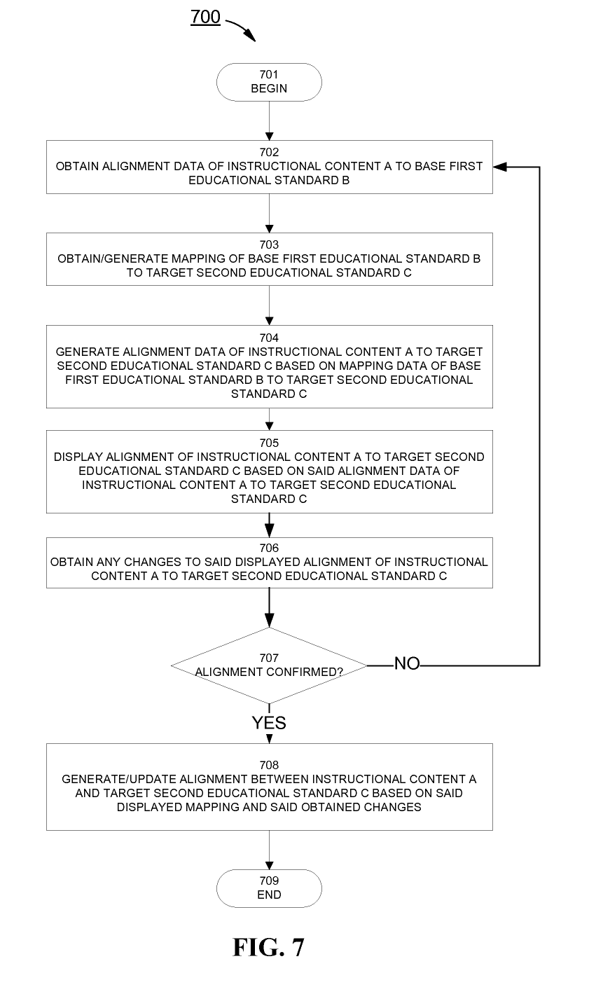

FIG. 7 is a flow chart illustrating, in more detail, step 207 of FIG. 2 using an exemplary process 700. Although the process 700 illustrates an alignment between instructional content and standards, the same process 700 can, in certain embodiments, be used for mapping between standards.

The process 700 proceeds from beginning step 701 to step 702 in which alignment data of base instructional content, “A,” to base first educational standard, “B,” is obtained. In certain embodiments, this data (e.g., of alignments and mappings) is obtained from a data file, such as an XML file. Next, in step 703, a mapping of base first educational standard B to target second educational standard C is either obtained (e.g., from memory 108) or generated (e.g., by a user). The mapping may also be obtained from another user, who may have stored it in memory 108, or from outside the system 100. In step 704, alignment data is generated between base instructional content A to target second educational standard C based on the mapping of base first educational standard B to target second educational standard C. The process 700 proceeds from step 704 to step 705 in which the alignment of base instructional content A to target second educational standard C is displayed based on the mapping of base instructional content A to target second educational standard C. Next, in step 706, any changes to the displayed alignment of base instructional content A to target second educational standard C are obtained. In decision step 707, the process 700 waits for the alignment of steps 705 and 706 to optionally be confirmed. Once the alignment of steps 705 and 706 is confirmed in decision step 707, the process 700 proceeds to step 708 in which the alignment between base instructional content A and target second educational standard C is generated/updated based on the displayed mapping and obtained changes that were confirmed in decision step 707, otherwise, the process 700 returns to step 702. In certain embodiments, the number of associations that were changed, updated, or otherwise applied is displayed. In certain embodiments, the number of associations that were not changed, not updated, or not otherwise applied is displayed. The generated alignment may optionally be recorded in a log. The process 700 then ends in step 709.

Having set forth in FIG. 7 a process 700 by which base instructional content is re-aligned to a target standard using the instructional content and standards alignment processing system 100 of FIG. 1, an example will now be presented using the process 700 of FIG. 7, instructional content titled “Review Broadway Musicals,” and educational standards “Maryland Arts: Music (2005)” and “Maryland Arts: Theatre (2005).”

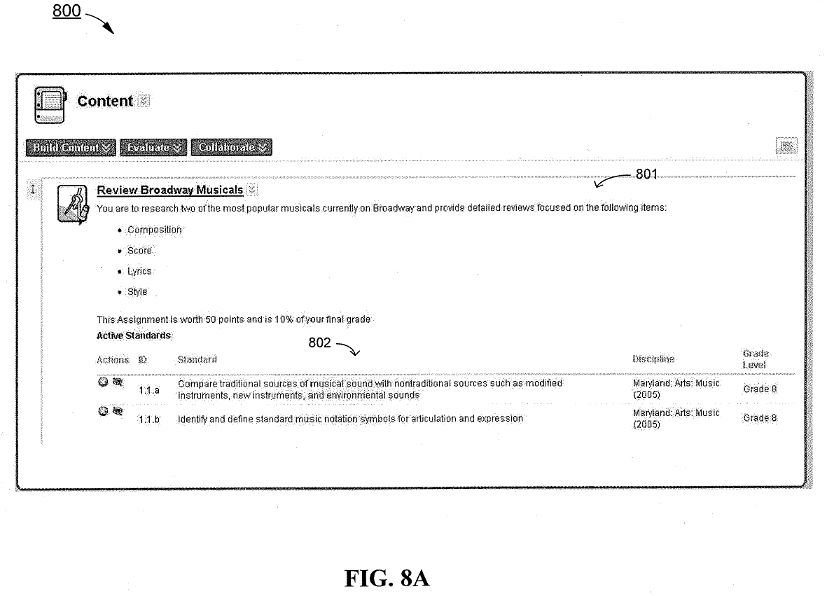

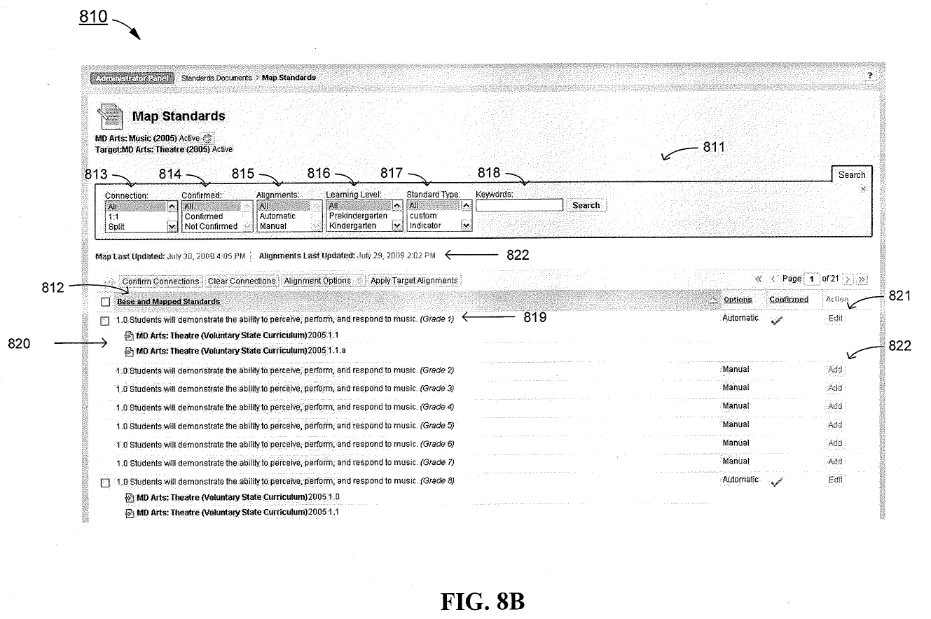

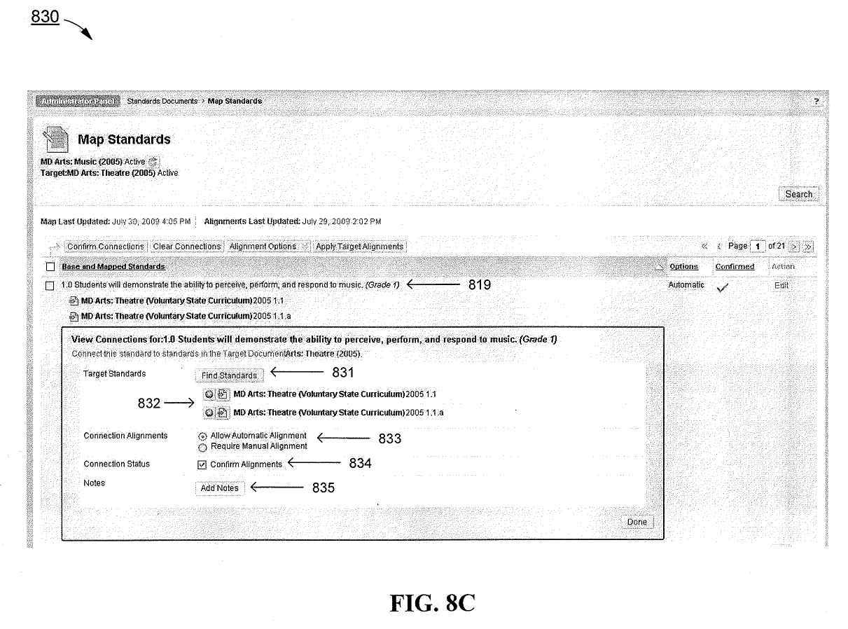

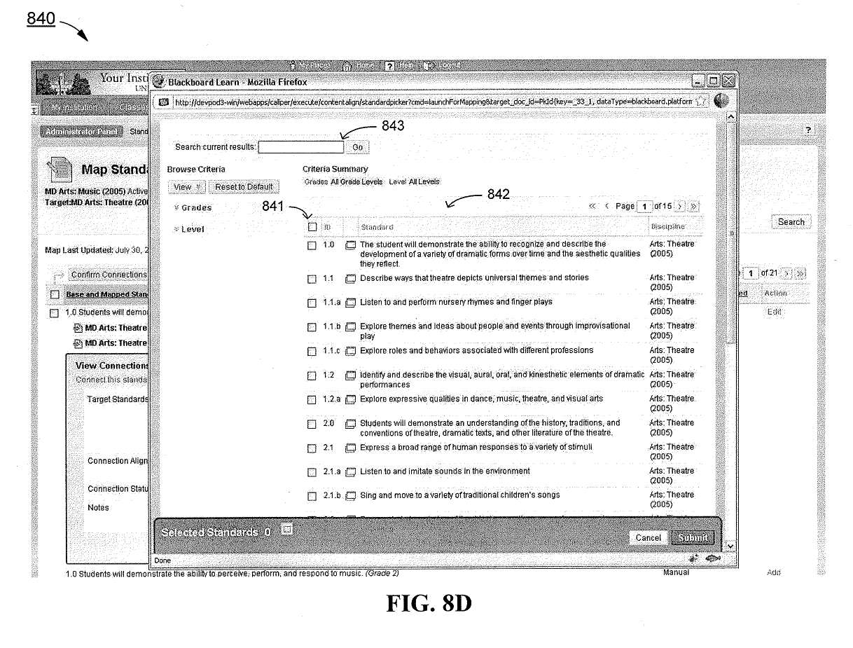

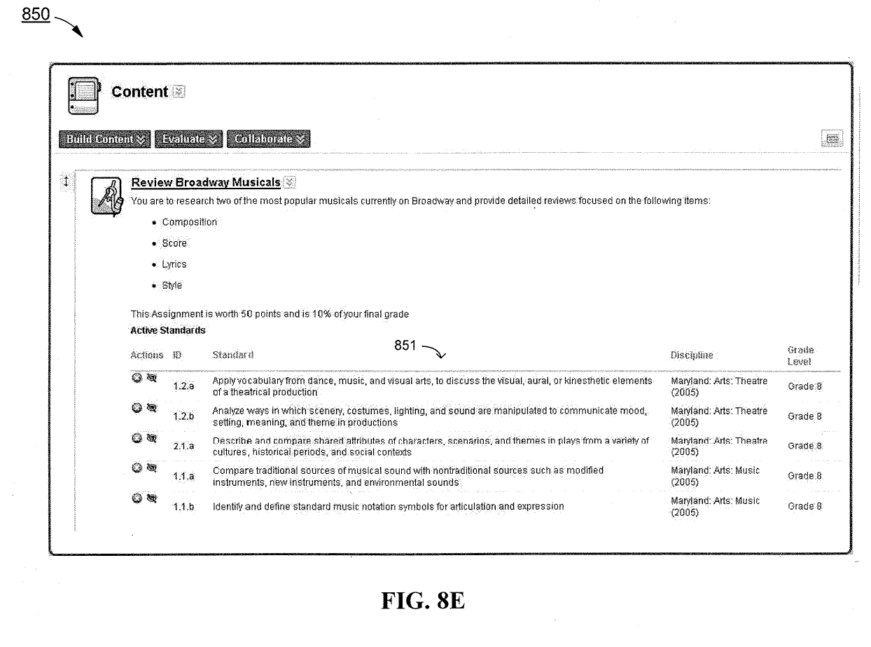

The process 700 proceeds from beginning step 701 to step 702 in which an alignment of instructional content, “Review Broadway Musicals,” (e.g., base instructional content A) to educational standard “Maryland Arts: Music (2005)” (e.g., base first educational standard B) is obtained. FIG. 8A is a sample screenshot, displayed by the display device 116 associated with the instructional content and standards alignment processing system 100 of FIG. 1, of base instructional content aligned to a base standard during the operation of FIG. 7.

Certain steps in the flow charts of FIGS. 2-7 may be performed by, or otherwise restricted to, user accounts having different user roles (or access privileges) in the system 100. For example, with reference to FIG. 7, the step 707 of confirming an alignment may be limited to a user account having an administrator role or instructor role in the system 100. As another example, a user account having an instructor role associated with a certain course can update alignments and mappings associated with that course, but not another course with which the user is not associated. As a further example, step 706, which allows changes to an alignment to be made, may be restricted to a user based on the context of the user's role in the system 100. The context includes, for example, a course associated with the user, a department associated with the user, and a school associated with the user. Other examples of role based access can be found in the learning management systems disclosed in U.S. Pat. Nos. 6,988,138 and 7,493,396, which are incorporated herein by reference in their entirety.

Specifically, FIG. 8A is a sample screenshot 800 of the alignment of “Review Broadway Musicals” to “Maryland Arts: Music (2005).” The “Review Broadway Musicals” instructional content is an assignment that includes certain requirements 801 to be completed. The “Review Broadway Musicals” instructional content has been aligned to two standards 802, “1.1.a” and “1.1.b,” each from the educational standard “Maryland Arts: Music (2005).” The alignment could have been created by various types of user accounts, such as an instructor user account or an administrator user account. Similarly, the “Review Broadway Musicals” instructional content could have been uploaded to the content data store 120 of the system 100 by the instructor user account that created the instructional content.

Next, in step 703, a mapping of the educational standard “Maryland Arts: Music (2005)” to the target educational standard “Maryland Arts: Theatre (2005)” is obtained. FIG. 8B is a sample screenshot 810 of base standards (from the base standard of “Maryland Arts: Music (2005)”) mapped to target standards from “Maryland Arts: Theatre (2005).” For example, base standard “1.0” 819 from the educational standard “Maryland Arts: Music (2005)” has been mapped to target standards “1.1” and “1.1.a” 820 from the target educational standard “Maryland Arts: Theatre (2005).” This mapping can be edited 821, as will be discussed below with reference to the screenshot 830 of FIG. 8C. New target standards can also be added 822 and mapped to the base standards that are displayed.

Included in the user interface displayed in the screenshot 810 is information 822 indicating the last time the map and alignments were updated. Also included in the user interface displayed in the screenshot 810 is a filter module 811 for selecting filters to remove from the list 812 of base and mapped standards. The filter module 811 allows a user to filter the list 812 according to connection 813, confirmation status 814, alignment type 815, learning level 816, standard type 817, and keyword 818. Connection types include a 1:1 connection, split connection, or merge connection. A 1:1 connection is a mapping from one educational standard to another educational standard. A split connection is a mapping from one educational standard to a plurality of other educational standards. A merge connection is a mapping from multiple educational standards to one educational standard. In certain embodiments, a merge connection cannot be filtered. The confirmation status 814 indicates whether the mapping of one educational standard to another educational standard has been confirmed by a user account. The alignment type 815 indicates whether instructional content aligned to a base standard will be automatically re-aligned to an appropriate target standard by the system 100, or whether some manual intervention is required (e.g., by a user) for the re-alignment. In certain embodiments, automatic alignments, once re-aligned, automatically re-align to any future updated mappings. For example, if an institution creates a custom standard, and maps the custom standard to several available standards, then instructional content, once aligned to the custom standard, will be automatically aligned to the several available standards. The learning level 816 indicates the learning level associated with the base educational standard (e.g., prekindergarten, kindergarten, Grade 1, etc.), and the standard type 817 indicates the type of standard (e.g., a custom standard generated by a user). The keyword box allows a user to search the list 812 of base and mapped standards according to a keyword provided by the user. In certain embodiments, a user can search for instructional content aligned to a selected standard based on any association of the instructional content with the selected standard, and similarly find another standard aligned to the selected standard based on any association of the instructional content with the selected standard.

FIG. 8C is a sample screenshot 830 of a user interface for modifying the mapping of FIG. 8B. Specifically, FIG. 8C is a sample screenshot 830 of a user interface for editing a portion of the mapping from the educational standard “Maryland Arts: Music (2005)” to the target educational standard “Maryland Arts: Theatre (2005).” A user can find additional standards to map to the base standard 819 by clicking on the “find” button 831, which will take the user to the user interface shown in FIG. 8D, discussed in further detail below. A user can also delete (e.g., by clicking on the delete icon) 832 standards that are currently mapped to the base standard 819, and select 833 whether the alignment to the base standard can be automatic or must be manually generated (e.g., by a user). A user can further confirm 834 the current mappings and optionally add notes 835 to the mappings, for example, explaining why the user has chosen to map two standards from “Maryland Arts: Theatre (2005)” to base standard “1.0” from “Maryland Arts: Music (2005).”

FIG. 8D is a sample screenshot 840 of a user interface for adding additional target standards to the mapping of FIG. 8B. Using checkboxes 841 and filters 843, a user can locate and select additional “Maryland Arts: Theatre (2005)” standards from the list of displayed standards 842 to map to base standard “1.0” from “Maryland Arts: Music (2005).”

In step 704, alignment data is generated between base “Review Broadway Musicals” to target “Maryland Arts: Theatre (2005)” based on the mapping of “Maryland Arts: Music (2005)” to “Maryland Arts: Theatre (2005)” displayed in FIG. 8B. The process 700 proceeds from step 704 to step 705 in which the alignment of “Review Broadway Musicals” to “Maryland Arts: Theatre (2005)” is displayed, as illustrated in FIG. 8E, based on the mapping of “Review Broadway Musicals” to “Maryland Arts: Theatre (2005)” of prior step 704.

FIG. 8E is a sample screenshot 850 of the displayed alignment between “Review Broadway Musicals (2005)” to “Maryland Arts: Theatre (2005).” Specifically, FIG. 8E is an example of the results of executing a re-aligned map for the instructional content “Review Broadway Musicals” to a different base educational standard, the “Maryland Arts: Theatre (2005)” standard, than the base educational standard “Review Broadway Musicals (2005)” illustrated in FIG. 8C. As illustrated, instructional content “Review Broadway Musicals” is aligned 851 to both standards from the “Maryland Arts: Theatre (2005),” and standards from “Maryland Arts: Music (2005)” as illustrated in FIG. 8A. In certain embodiments, the pre-existing alignments with the “Maryland Arts: Theatre (2005)” standard are maintained. In certain embodiments, the pre-existing alignments with the “Maryland Arts: Theatre (2005)” standard are deleted upon user request.

In step 706, a user is prompted to make changes to the displayed alignment between “Review Broadway Musicals” to “Maryland Arts: Theatre (2005)” illustrated in FIG. 8E. The user makes no changes to the alignment, and in decision step 707, the user confirms the alignment illustrated in FIG. 8E. In step 708, the alignment displayed in FIG. 8E is generated (e.g., stored in associations data store 122) based on the confirmation of decision step 707. The process 700 then ends in step 709.

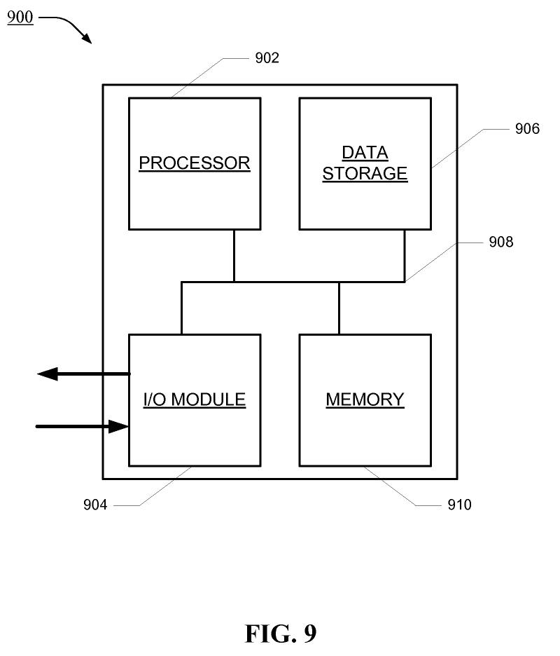

FIG. 9 is a block diagram illustrating an example of a computer system with which the instructional content and standards alignment processing system 100 of FIG. 1 can be implemented. In certain embodiments, the computer system 900 may be implemented using software, hardware, or a combination of both, either in a dedicated server, or integrated into another entity, or distributed across multiple entities.

Computer system 900 includes a bus 908 (e.g., communications bus 120 from FIG. 1) or other communication mechanism for communicating information, and a processor 902 (e.g., processor 104 from FIG. 1) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. Computer system 900 also includes a memory 910 (e.g., memory 108 from FIG. 1), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The instructions may be implemented according to any method well known to those of skill in the art, including computer languages such as system languages (e.g., C, C++, Assembly), architectural languages (e.g., Java), and application languages (e.g., PHP, Ruby, Perl, Python). Memory 910 may also be used for storing temporary variable or other intermediate information during execution of instructions to be executed by processor 902. Computer system 900 further includes a data storage device 906, such as a magnetic disk or optical disk, coupled to bus 908 for storing information and instructions.

Computer system 900 may be coupled via I/O module 904 to a display device (e.g., display device 116 from FIG. 1), such as a CRT or LCD for displaying information to a computer user. An input device (e.g., input device 114 from FIG. 1), such as, for example, a keyboard, or a mouse may also be coupled to computer system 900 via I/O module 904 for communicating information and command selections to processor 902.

According to one aspect of the present disclosure, a system for re-aligning instructional content can be implemented using a computer system 900 in response to processor 902 executing one or more sequences of one or more instructions contained in memory 910. Such instructions may be read into memory 910 from another machine-readable medium, such as data storage device 906. Execution of the sequences of instructions contained in main memory 910 causes processor 902 to perform the process steps described herein. One or more processors in a multi-processing arrangement may also be employed to execute the sequences of instructions contained in memory 910. In alternative embodiments, hard-wired circuitry may be used in place of or in combination with software instructions to implement various embodiments of the present disclosure. Thus, embodiments of the present disclosure are not limited to any specific combination of hardware circuitry and software.

The term “machine-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 906. Transmission media include coaxial cables, copper wire, and fiber optics, including the wires that comprise bus 908. Transmission media can also take the form of acoustic or light waves, such as those generated during radio frequency and infrared data communications. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

The embodiments of the present disclosure provide a system in each alignment of curriculum content to a base standard can be automatically re-aligned to a target standard. Accordingly, a user does not manually re-align each alignment of the curriculum content between the base standard and target standard.

The systems described and incorporated above could be a single system or a composite of separate but integrated systems serving interrelated purposes. For example, the systems can be managed by, or hold data from, different units or departments within a single institution. The system can be managed by, or hold data from, different institutions, such as separate schools within a school district. The systems can be configured to process different types of data, such as outcomes and assessment data, educational resources and their metadata, and courses and their enrollments, including users with different roles in different courses.

The disclosed systems include business logic that can implement the processes described herein across multiple systems. For example, the disclosed systems are configured to include logic for data that is archived or exported from one system, stored, and later imported into a different system. The disclosed systems are also configured to include logic for data that is transferred back and forth between the systems (e.g., on demand or automatically updated). The disclosed systems are yet further configured to include logic for data that is shared (e.g., in a live fashion) across the systems, business logic determined by the data in one system that can impact the process in a different system, and decisions and confirmations by users in one system that can impact the process in a different system.

Any component of the examples above or of processes described herein could be performed on separate systems with different users, where the systems are integrated and transfer or share data to complete the process across the different systems. This separation of systems allows institutions to manage systems in different parts of the organization and integrate existing systems with new systems to further enable content and standards alignment processing. For example, tests that include questions aligned to standards are taken in courses in a course management system. The results of these tests are processed by an outcomes system. Based on those results, the outcomes system provides reports on which standards are or are not being adequately met. This data is transferred to an educational resources management system, where users can map additional content alignments to standards to further address these and other standards. These mappings can be pushed out to courses in the course management system, and the test cycle can be repeated until adequate results are achieved.

As another example, one office at an institution manages the system that stores standards. A different office at the institution manages the system that stores educational resources. Users across these two systems exchange data to align standards to educational resources and map additional standards to educational resources. These alignments and mappings must be confirmed by users in a third system where outcomes and assessment data is managed. The users involved in this process may or may not have access to the other separate systems, but the systems are integrated such that components of the process can occur on different systems and the process can be completed.

As another example, a publisher of educational resources may produce and store resources on a system external to the standards alignment processing system. These educational resources may be aligned to standards by the publisher. When the educational resources are selected for use in a course management system, the standards alignments that come with these resources can be automatically mapped to additional or replacement standards by the standards alignment processing system. The re-mapped alignments could be used internally to the standards alignment processing system, internally to the course management system, or they could be communicated back to the publisher's educational resources system. Additionally, the publisher may provide no standards aligned to their educational resources, but the standards alignments could be produced and stored on a system that is separate from the system that stores the educational resources. In either case, standards alignments could be mapped and re-aligned regardless of the storage location of the educational resources.

Those of skill in the art would appreciate that the various illustrative blocks, modules, elements, components, methods, and algorithms described herein may be implemented as electronic hardware, computer software, or combinations of both. Furthermore, these may be partitioned differently than what is described. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An instructional content and standards alignment processing system comprising:
a computer-readable memory configured to store information indicative of instructional content, a first educational standard, and a second educational standard, and configured to store at least one alignment between the instructional content and the first educational standard and at least one mapping between the first educational standard and the second educational standard; and
a processor configured to automatically generate at least one alignment between the instructional content and the second educational standard based on the at least one mapping between the first educational standard and the second educational standard,
wherein the computer-readable memory is configured to store the at least one alignment between the instructional content and the second educational standard after the at least one alignment is confirmed by a user.

2. The system of claim 1, wherein at least one of the instructional content, the first educational standard, and the second educational standard are obtained from an interface with an external system.

3. The system of claim 2, wherein, after the at least one alignment is generated, at least one of the instructional content, the first educational standard, the second educational standard, and the at least one alignment are provided to an external system through an interface with the external system.

4. The system of claim 2, wherein the external system comprises an outcomes assessment system.

5. The system of claim 1, wherein the at least one alignment between the instructional content and the second educational standard generated based on the at least one mapping between the first educational standard and the second educational standard, is also generated based on at least one of an alignment between the instructional content and a second instructional content, or a metadata of the instructional content.

6. The system of claim 1, wherein access, by the user, to at least one of the instructional content, the first educational standard, the second educational standard, and the at least one alignment between the instructional content and the second educational standard, is restricted based on the user's role.

7. The system of claim 6, wherein the access comprises a right to add, modify, delete, confirm, or manage the at least one of the instructional content, the first educational standard, the second educational standard, and the at least one alignment between the instructional content and the second educational standard.

8. The system of claim 6, wherein the access is also restricted based on the context of the user's role.

9. The system of claim 1, wherein at least one of the instructional content, the first educational standard, and the second educational standard, is generated external to the system.

10. The system of claim 1, wherein at least one of the instructional content, the first educational standard, and the second educational standard, is imported into the computer-readable memory from a computer-readable memory external to the system.

11. The system of claim 1, further comprising:
an output module configured to display, to the user, information indicative of the at least one alignment between the instructional content and the second educational standard; and
an input module configured to receive, from the user, information indicative of whether the at least one alignment between the instructional content and the second educational standard is confirmed.

12. The system of claim 11, wherein the input module is also configured to receive, from the user, information indicative of the user's input regarding the at least one alignment of the instructional content with the second educational standard.

13. The system of claim 11, wherein the output module is also configured to store information indicative of the at least one alignment between the instructional content and the second educational standard.

14. The system of claim 13, wherein the stored information comprises information identifying the user, and information indicative of a time at which the at least one alignment between the instructional content and the second educational standard was created.

15. The system of claim 11, wherein the output module is also configured to display information indicative of the status of the at least one alignment between the instructional content and the second educational standard.

16. The system of claim 11, wherein the processor is configured to automatically generate a plurality of alignments between the instructional content and the second educational standard based on the at least one mapping between the first educational standard and the second educational standard, and wherein the output module is configured to display the plurality of alignments between the instructional content and the second educational standard.

17. The system of claim 16, wherein the processor is configured to filter, based on input from the user, the display of the plurality of alignments between the instructional content and the second educational standard.

18. A method for associating instructional content, comprising:
receiving at least one alignment between instructional content and a first educational standard, and at least one mapping between the first educational standard and a second educational standard;
generating at least one alignment between the instructional content and the second educational standard based on the at least one mapping between the first educational standard and the second educational standard;
receiving, from a user, a confirmation of the at least one alignment between the instructional content and the second educational standard; and
storing the confirmed at least one alignment between the instructional content and the second educational standard.

19. The method of claim 18, wherein at least one of the instructional content, the first educational standard, and the second educational standard are obtained from an outcomes assessment system.

20. The method of claim 18, wherein the at least one alignment between the instructional content and the second educational standard generated based on the at least one mapping between the first educational standard and the second educational standard, is also generated based on at least one of an alignment between the instructional content and a second instructional content, or a metadata of the instructional content.

21. The method of claim 18, wherein access, by the user, to at least one of the instructional content, the first educational standard, the second educational standard, and the at least one alignment between the instructional content and the second educational standard, is restricted based on the user's role.

22. The method of claim 18, wherein at least one of the instructional content, the first educational standard, and the second educational standard, is generated external to the system.

23. The method of claim 18, wherein at least one of the instructional content, the first educational standard, and the second educational standard, is imported into the computer-readable memory from a computer-readable memory external to the system.

24. The method of claim 18, further comprising displaying, to the user, information indicative of the at least one alignment between the instructional content and the second educational standard.

25. The method of claim 18, further comprising receiving, from the user, information indicative of the user's input regarding the at least one alignment of the instructional content with the second educational standard.

26. The method of claim 18, further comprising storing information indicative of the at least one alignment between the instructional content and the second educational standard, wherein the stored information comprises information identifying the user, and information indicative of a time at which the at least one alignment between the instructional content and the second educational standard was created.

27. The method of claim 18, further comprising displaying information indicative of the status of the at least one alignment between the instructional content and the second educational standard.

28. The method of claim 18, further comprising:
generating a plurality of alignments between the instructional content and the second educational standard based on the at least one mapping between the first educational standard and the second educational standard; and
displaying the plurality of alignments between the instructional content and the second educational standard.

29. The method of claim 28, further comprising filtering, based on input from the user, the display of the plurality of alignments between the instructional content and the second educational standard.

30. A computer-readable medium having computer-executable instructions for causing a processor to execute instructions to associate instructional content by performing steps comprising:
receiving at least one alignment between instructional content and a first educational standard, and at least one mapping between the first educational standard and a second educational standard;
generating at least one alignment between the instructional content and the second educational standard based on the at least one mapping between the first educational standard and the second educational standard;
receiving, from a user, a confirmation of the at least one alignment between the instructional content and the second educational standard; and
storing the confirmed at least one alignment between the instructional content and the second educational standard.
